(19) United States
(12) Patent Application Publication
(10) Pub. No.: US 2009/0109961 A1
(43) Pub. Date: Apr. 30, 2009

(54) MULTIPLE SIMULTANEOUS CALL MANAGEMENT USING VOICE OVER INTERNET PROTOCOL

(76) Inventors: John Michael Garrison, Austin, TX (US); Michael S. McKay, Round Rock, TX (US)

Correspondence Address: IBM CORP (YA);C/O YEE & ASSOCIATES PC, P.O. BOX 802333, DALLAS, TX, 75380, US

(21) Appl. No.: 11/931,406

(22) Filed: Oct. 31, 2007

(51) Int. Cl. H04L 12/66

(52) U.S. Cl. 370/352

(57) ABSTRACT

Illustrative embodiments provide a computer implemented method, apparatus, and computer program product for more effectively managing multiple call situations using voice over internet protocol. In one illustrative embodiment, the computer implemented method comprising, responsive to receiving a request to monitor a call from among multiple simultaneous calls using voice over internet protocol, creating a set of trigger criteria for the call and monitoring the call for the set of trigger criteria. Responsive to one of the set of trigger criteria having been met, identifying a triggered criteria and selectively invoking a rule with respect to the triggered criteria to produce a result, and notifying a requester of the result.

### BACKGROUND OF THE INVENTION

1. Field of the Invention

The present invention relates generally to an improved data processing system, and in particular to a computer implemented method, an apparatus and a computer program product for multiple simultaneous call management using voice over internet protocol (VOIP).

2. Description of the Related Art

Telephone calls typically involve either a pair of single parties or multiple parties, as in a conference call. For example, in a multiple call situation, first and second parties are participating in a call when a third party calls the first party. In this example, the first party is the receiver and the third party is the caller. Because the first party was busy, the third party may be placed on hold. The caller, when placed on hold, does not hear any of the receiving party's conversation with the second party, nor does the receiving party hear anything from the caller, on hold.

In another example, during a conference call a user may decide to partially opt out of participating and passively listen with the call muted from the user's perspective. Mute cancels the microphone input of the user station and does not allow the user to speak and be heard by other parties on the call. The speaker component, however, is not muted, allowing the user to hear the other conference participants.

When the user is involved in a number of calls it may become problematic to keep track of what is happening on each call. Points of interest may be missed as the user switches among the calls to activate one call, then another call, allowing the user to listen or speak, or both. Inevitably information is missed or the call is dropped during the switching activity. Further, time may be lost when participating on a call, for which a presence was requested, but a need never materialized. A requirement therefore exists for a capability to more effectively manage multiple call situations.

### SUMMARY OF THE INVENTION

Illustrative embodiments provide a computer implemented method, an apparatus, and a computer program product for multiple simultaneous call management using voice over internet protocol. In one illustrative embodiment, the computer implemented method comprising, responsive to receiving a request to monitor a call among multiple simultaneous calls using voice over internet protocol, creating a set of trigger criteria for the call and monitoring the call for the set of trigger criteria. Responsive to one of the set of trigger criteria having been met, identifying a triggered criteria and selectively invoking a rule with respect to the triggered criteria to produce a result, and notifying a requester of the result.

In another illustrative embodiment, apparatus of the data processing system comprising: a receiver responsive to receiving a request to monitor a call among multiple simultaneous calls using voice over internet protocol, capable of creating a set of trigger criteria for the call, a monitor capable of monitoring the call for the set of trigger criteria, responsive to one of the set of trigger criteria having been met, identifying a triggered criteria, a rule processor capable of selectively invoking a rule with respect to the triggered criteria to produce a result; and a notifier capable of notifying a requester of the result.

In another illustrative embodiment, the computer program product comprising computer executable program code embodied on a computer usable recordable type medium, the computer executable program code comprising, computer executable program code for receiving a request to monitor a call among multiple simultaneous calls using voice over internet protocol, creating a set of trigger criteria for the call, computer executable program code for monitoring the call for the set of trigger criteria, computer executable program code responsive to one of the set of trigger criteria having been met, for identifying a triggered criteria, computer executable program code for selectively invoking a rule with respect to the triggered criteria to produce a result, and computer executable program code for notifying a requester of the result.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a communication device in which illustrative embodiments may be implemented;

FIG. 4 is a block diagram of components in an implementation of an illustrative embodiment;

FIG. 5 is a flowchart of a call management process in an implementation of an illustrative embodiment;

FIG. 6 is a flowchart of a monitoring process of FIG. 5 in an implementation of an illustrative embodiment;

FIG. 7 is a block diagram of a multiple call interaction in an illustrative embodiment; and

FIG. 8 is a block diagram of a conference call interaction in an illustrative embodiment.

### DETAILED DESCRIPTION OF THE PREFERRED EMBODIMENT

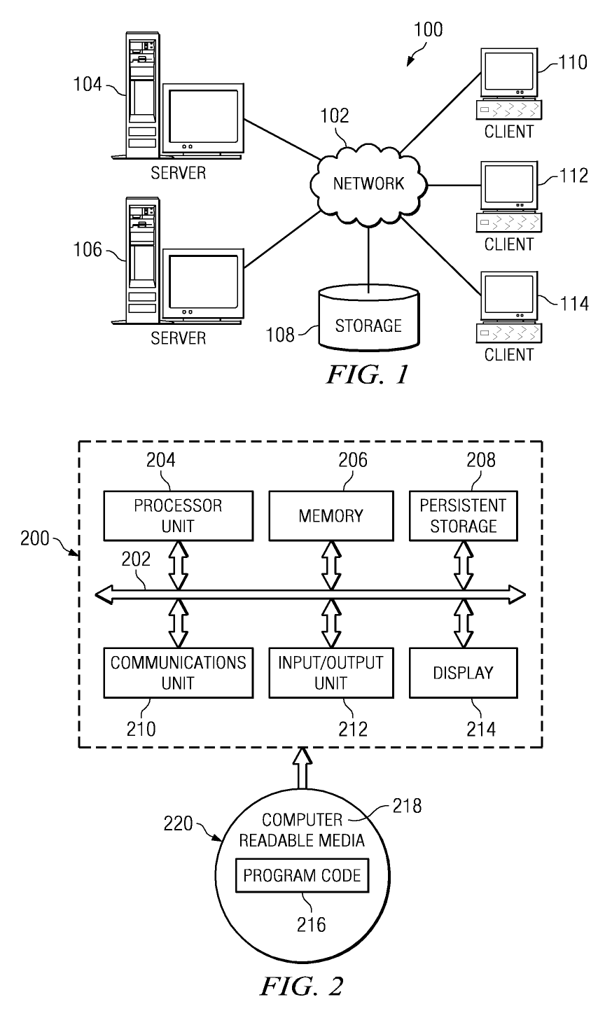

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, computer executable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

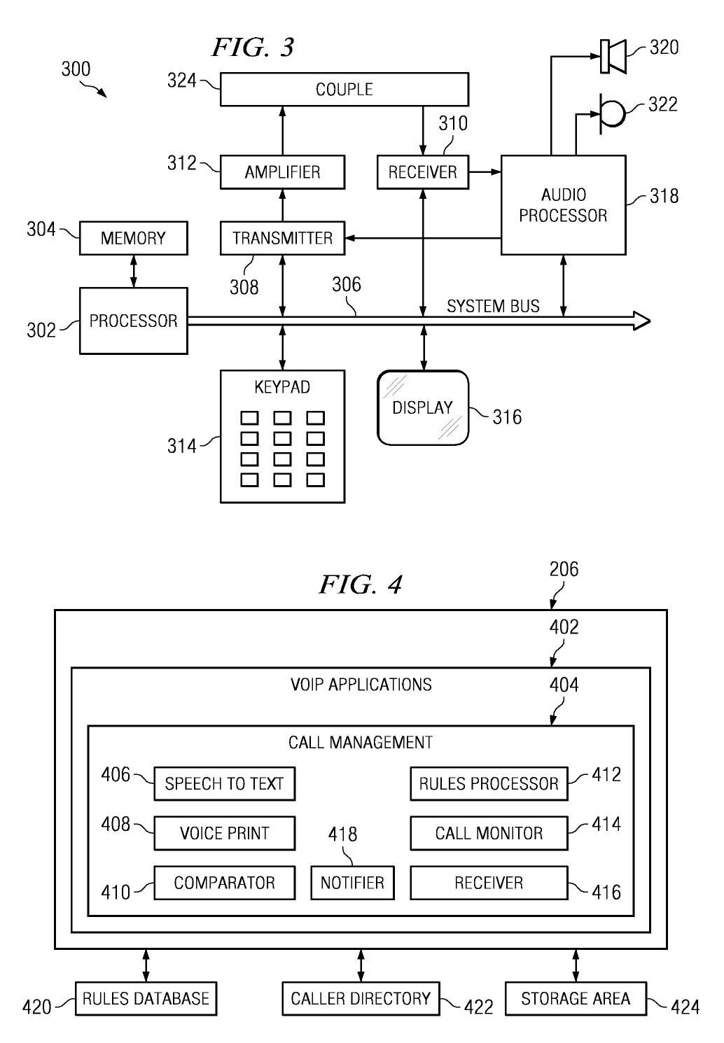

With reference to FIG. 3, a block diagram of a communication device in which the present invention may be implemented is shown. Communication device 300 includes a processor 302 for controlling operation of the communication device and a memory 304. The processor 302 may be a general-purpose microprocessor operating under the control of instructions stored a memory, such as memory 304, or device-specific circuitry for controlling the operation of the telephone device. Processor 302 is connected by system bus 306 to transmitter 308, receiver 310, keypad 314, display 316, and audio processor 318. Keypad 314 may be a keypad and/or buttons. Display 316 may be any type of display device including a liquid crystal display (LCD) or other known displays, such as a cathode ray tube or active matrix display.

Transmitter 308 and receiver 310 are coupled to a telephone signal by couple 324 to provide full duplex communication. The telephone signal may be provided by a telephone line (not shown) in a land-based telephone or an antenna, such as for a wireless telephone. Audio processing circuit 318 provides basic analog audio outputs to speaker 320 and accepts analog audio inputs from microphone 322. Received signals are demodulated and decoded by receiver 310. Transmitter 308 encodes and modulates signals passed to it by processor 302 or audio processor 318. The output of the transmitter is amplified by power amplifier 312 to control the power level at which the signal is transmitted.

Processor 302 or audio processor 318 may detect audible call status information and call status codes received by receiver 310. Memory 304 may include a lookup table associating call status information or call status codes with visual call status information, such as text messages. Processor 302 detects or receives a call status code and displays an appropriate call status message on display 316.

Those of ordinary skill in the art will appreciate that the hardware depicted in FIG. 3 may vary and that the function may also be provided by means of software implemented on a client system such as client 110 of FIG. 1. Examples of software implemented telephones communicating using Internet Protocol telephony include Vonage™ Softphone™.

Illustrative embodiments provide a set of capabilities to analyze a specific call or calls, to determine the existence of specific elements or events as they relate to the calls, and to initiate predetermined actions in accordance with the identified elements or events. The process may typically occur in the background, only notifying the requester when necessary, thereby allowing the requester to perform other tasks concurrent with the process.

For example, there may be the need to listen to multiple phone calls simultaneously and determine the level of participation needed on a specific call. In one example, in a call waiting situation, a user may be waiting, also known as camped, simultaneously on two conference calls, one designated as a primary call, with the other designated a secondary or background call in which the user is mostly listening. Using call management capabilities to analyze the call, allows a more passive approach to attending such calls. A call management process can monitor the calls and alert the user when the user defined criteria for notification has been met.

Notification criteria may be established in the form of triggers. Triggers allow for conditional processing based on determining whether a defined attribute and value combination exists. A trigger is an instance of a condition. The condition is defined by the attribute and value combination. The trigger is then further complimented by a rule combining the trigger, in the form of a condition, with an action, in response to the condition.

For example a trigger may be defined as “user john”, wherein the attribute is “user” and the value is “john.” A rule comprising a condition and associated action may then be defined as “if user=x, then alert user y”, where “x” and “y” may be readily substituted. A number of triggers comprising trigger criteria can then gathered to form a set of triggers and stored for later reference and use.

Monitoring of a call would then comprise using one or more of a set of trigger criteria comprising voice, keyword or event triggers and determining if conditions specified within the triggers is met. In the previously described call situation, if a trigger occurred, the conditions of the criteria were met thereby identifying triggered criteria, in the secondary or background call. In this example, a rule may be processed that notifies the user by flashing the background call window or adjusting the volume causing the user to take notice of the change.

With reference to FIG. 4 a block diagram of components of an illustrative embodiment is shown. Functioning within a memory of a system, such as memory 206 in an instance of data processing system 200 of FIG. 2 or communication device 300, of FIG. 3, voice over Internet Protocol (VOIP) applications 402 may be viewed as a collection of applications designed to provide enhanced service offerings related to telephony. Enhanced service offerings may include updated communication applications such as conference calling and suspending or placing calls on hold. Although some function may have existed in the past, newer versions offer extended capabilities allowing users to have more control.

Call management 404 is one application that may be a part of the collection of voice over Internet Protocol (VOIP) applications 402. Call management system 404 further comprises and coordinates a set of components, such as a speech to text converter 406, voice print service 408, comparator 410, rules processor 412, call monitor 414, receiver 416, and notifier 418.

Speech to text converter 406 is a service that is used to convert the spoken form of language into a written form of language and store the result on a storage device. The results may then be further processed by a computer to compare and identify words, terms and phrases deemed to be of interest. This service provides the foundation for keyword searching operations. Speech to text conversion tools are readily available for free or for a fee from a number of vendors.

Voice print service 408, provides a capability to take a digital snapshot of a speaker's voice, such as when callers announce themselves at the start of, or during a call. The digital image may then be compared and matched with a label, name, or other user identifier. Another form of voice recognition software, voice capture tools are also available.

Comparator 410 provides a comparison or matching function used to evaluate a runtime value against a previously defined value. For example, the comparator may be used to determine if a speech to text converted term or phrase matches a predetermined value. Upon determining the comparison to be true a configurable action may be taken.

Rules processor 412 initiates action defined in a rule, wherein the rule was selected based on a compare operation. Typical rules have the form of a condition and corresponding action portions. If the condition is met, as determined by the comparator 410, then rules processor 412 will invoke a specified action portion of the rule. A rule selector is a part of the rule processor 412. The selector determines which rule is in effect based on the event or activity triggered.

For example, if the comparator 410 determined that a number of users on the call being monitored by call monitor 414 had reached a predetermined threshold, an event based threshold rule would be invoked, in particular the number of callers or call participant rule. In another example, if the trigger was caller name or user name based and the particular caller was identified on the call, then a caller based rule would be selected.

Call monitor 414 provides a capability to analyze events or activities related to a specified call. Call monitor 414 examines the ongoing call for the existing, predetermined conditions or events. For example, call monitor 414 is capable of determining if conditions for previously defined triggers have been met. In one example, a previously defined trigger may have a condition related to when specific callers join and leave a call, and when certain words or phrases are mentioned in the call. Using this example, a trigger may be set for a specific identified caller “A”. During the call, the previously defined trigger condition is met when caller “A” joins the call. Call monitor 414 works in conjunction with the other components to provide this level of runtime capability.

Call monitor 414 may be requested to monitor a call or calls in the background where the requester is not part of the actual call. The caller requesting the monitoring must be authorized to participate, otherwise no monitoring can occur. For example, a user was requested to participate in a conference call, but decides to monitor rather than actively participate. The user relies on the monitor to alert the user of a need to be present on the call, with the monitoring activity totally in the background. This type of monitoring may be particularly useful when a user is requested to participate on a call, but is routinely not expected to contribute unless specifically required.

In another example, as a result of monitoring a call, a trigger, based on an attribute, such as the priority of the call, may be tripped and the resulting rule executed to automatically adjust the volume of a given call based upon call priority. For example, if two concurrent calls are represented in two separate “windows”, the foreground window, either on the desktop or on the foremost window in a multiple document interface (MDI) would output at full volume level. A background window on the desktop or multiple document interface would only output at one tenth volume level, with both volume levels being configurable by the user requesting the monitoring. In addition, background windows would automatically be configured to mute incoming sounds.

Receiver 416 provides a capability of receiving requests for call management services from requesters. In one example, a requester may be an individual user of the voice over Internet Protocol applications 402. In another example, a requester may be a machine, such as a client machine, a system, such as collection of data processing machines, a service, such as a web service, or an application or programmatic device, such as personal digital assistant or cellular phone, issuing a request for services.

Notifier 418 provides notification in the form of results or messages. A result may be an alert, such as a trigger event occurring causing a window associated with a monitored call to flash, whereas a message may be a specific message sent to a requester indicating a certain user has joined a call that was being monitored.

In addition to the services just described, supporting entries for a rules database 420 and a caller directory 422 may be provided. Rules database 420 provides the rules used by the rules engine. Rules provide the conditional response to triggers as encountered and determined by the monitor and comparator functions of call management 404 function of voice over Internet Protocol applications 402. Rules within the database are configurable and selectable.

A trigger and respective trigger value define the condition portion of the rule. An action is then defined for a respective trigger and value combination. A selected set of rules may then be created to comprise a set of trigger criteria determining what is to be monitored within the call.

Rules may be defined to support dynamic input from a user interface prompt or may consume input received from a target data source such as a configuration file. For example, a user interface may prompt a user to provide items to be monitored on a call. In response a user may provide an attribute and value pair as requested. The trigger, using the provided attribute and the related value from the user input may then be incorporated into a respective rule used during the monitoring. In another example, by the creation and modification of a property file or a configuration file related to the call management function the triggers and values may be provided for use with the rules. In another example, an editor may be provided to edit predefined rules directly for usage with a call.

Rules are established prior to invocation and loaded with the predetermined criteria of interest defined by a user or enterprise. The predetermined criteria of interest comprise the trigger criteria to be evaluated during the monitoring phase. Enterprise based values may be provided by default in a storage area 424, such as a property file or configuration file, whereas user specified values may be related to a user preference or for a per call basis and may be maintained in a similar storage area accessible to rules processor 412. For example, default values may be provided for rules related to identifying a caller based on a role, such as a chair of a conference call or by user, such as a company officer voice print. User selected values may relate to meeting topic keywords or significant caller voices.

Caller directory 422 may be provided to aid in identifying information needed to place a call to a respective user identified within a monitored call. For example, if during a call a specific user was requested to join the monitored call, a caller directory lookup may be performed and the identified user called.

Call management 404 application and other elements of the collection of voice over Internet Protocol (VOIP) applications 402 may be centrally located on a server, such as server 104 or may be replicated on specified clients, such as client 110 of FIG. 1. Location of the service may vary in accordance with the requirements and capabilities of the hosting system. A central location is typically better suited for access, performance, maintenance, and management purposes. Sufficient network bandwidth is presumed to allow the real time conversion of speech to text and the capture and analysis of voice prints to occur.

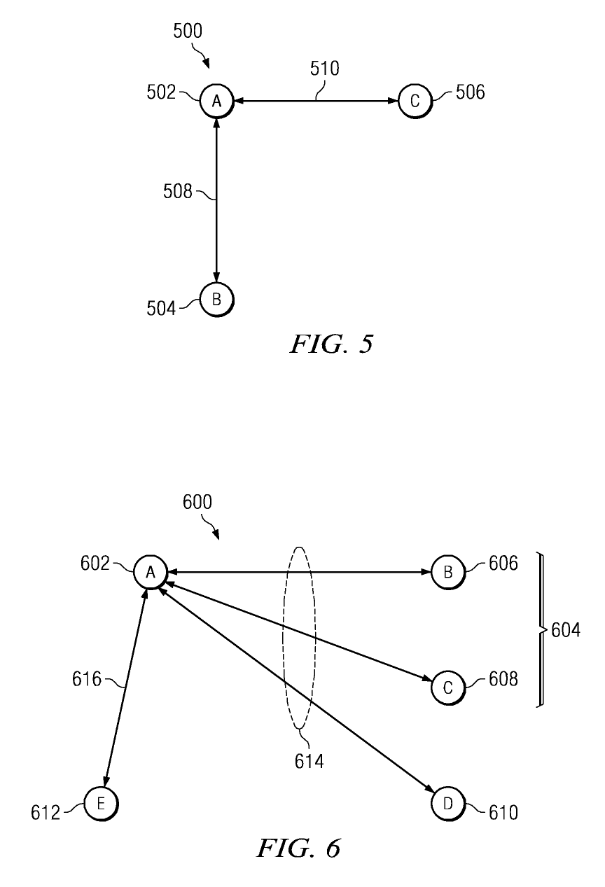

With reference to FIG. 5 a block diagram of a multiple call interaction in an illustrative embodiment is shown. The callers A 502, B 504, and C 506 may be instances of clients 110, 112 and 114 connected by network 102 to servers 104 and 106 of FIG. 1. In this example of a three way multiple call 500, caller A 502 is in a first conversation 508 with caller B 504. Caller A 502 receives a second call 510 from caller C 506. Caller A 502 places caller B 504 on hold and initiates monitoring of first call 508. First call 508 may be set to a lower volume level, but caller A 502 can still listen. Caller A 502 is able to hear both caller B 504 and caller C 506, with caller C 506 having a higher volume setting. For example, when a caller's name is recognized or a topic keyword is stated in a background call, such as monitored first call 508, a rule processor may process a rule to flash the background window of first call 508 or use a popup to notify caller A 502 to switch to the background call.

In the current example, caller B 504 does not hear caller A 502 while on hold, or caller C 506 at any time. Caller C 506 cannot hear caller B 504.

With reference to FIG. 6, a block diagram of a conference call interaction in an illustrative embodiment is shown. In this example, similar client and server arrangements as in FIG. 5 are extended to accommodate the multiple caller scenario of a conference call concurrently with additional calls. For example, in multiple call 600, there are multiple calls and multiple callers. Caller A 602 is on a conference call 604 with caller B 606 and caller C 608, when a call 614 is received from caller D 610. Further, caller A 602 calls caller E 612 and places the call 616 with caller E 612 on hold.

Caller A 602 monitors conference call 604 setting a combination of triggers, such as, caller id of a participant joining the call and keyword of a specific topic being discussed. Caller A 602 is then passively participating in conference call 604 and may choose to mute the call while attending to other tasks.

In a similar manner, the call 616 with caller E 612 may be monitored. For example, a trigger may be set to alert caller A 602 that a time limit for being on hold has expired, or a keyword has been mentioned by caller E 612, or another trigger, such as a new caller joining the call has occurred. Monitoring of the call allows caller A 602 to focus on the call 614 with caller D 610 until a triggered incident occurs on the monitored calls.

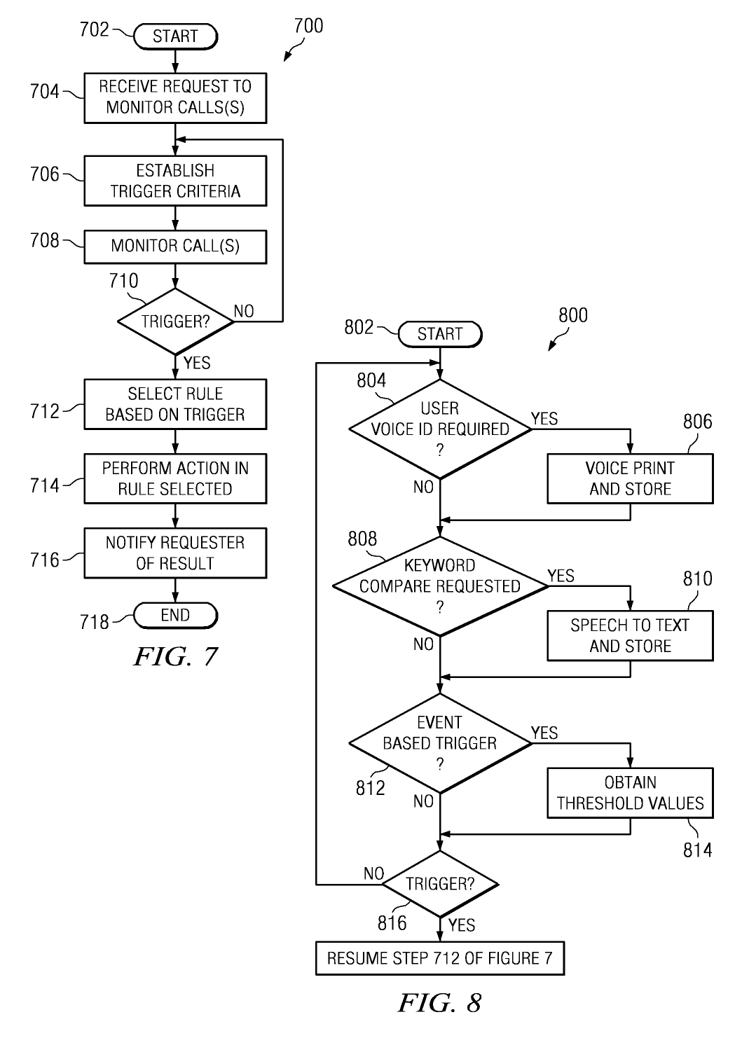

With reference to FIG. 7, a flowchart of a call management process in an implementation of an illustrative embodiment is shown. Process 700 of call management 404 of FIG. 4 begins at start (step 702) and receives a request to monitor a call (step 704). Triggers and respective trigger values are created as a set of trigger criteria to determine what is to be monitored within the call (step 706).

The triggers and their related values may be created for example, by the creation and modification of a properties file, configuration file or graphic user interface input related to the call and call management function. For example, creating a set of trigger criteria may comprise prompting a user to select rules, to be invoked, from a list of available rules. The trigger criteria being embedded in the selected rules.

In another example, a default configuration or property file containing predetermined rules comprising trigger criteria may be associated with certain calls. The collection of rules, having trigger criteria embedded within then forms the set of trigger criteria.

Monitoring a call and determining trigger criteria has been met establishes triggered criteria. Which trigger criteria has been met determines the rules and corresponding rule actions that will be executed.

The call is then monitored to detect the presence of the requested triggers having the predetermined trigger values (step 708). A comparison is performed to determine if a specified trigger has occurred (step 710). If in step 710, the result is a “no”, process 700 reverts to step 706 to create trigger criteria again. If a “yes” was determined in step 710, the presence of the requested triggers having the predetermined trigger values has been confirmed and rule selection based on the established triggered criteria encountered occurs (step 712).

The action specified in the rule selected in step 512 is performed (step 714). The results of performing the specified action is then communicated to the requester (step 716). Results may include a simple status message indicating completion of a request may involve the initiation of a call to another user or may be a prompt to a requester for further action, such as when a threshold is met and an alert is issued to the requester. Process 700 terminates thereafter (step 718).

With reference to FIG. 8, a flowchart of monitoring step 708 of FIG. 7 of an illustrative embodiment is shown. Monitor process 800, representing the monitoring performed in step 708, begins (step 802) and determines if a user voice identification was requested (step 804). If a “yes” is determined in step 804, a voice print is obtained from the participants of the call and stored for later processing (step 806). For example, when a determination is made to acquire voice print information, as each caller joins the call a digital snapshot of the caller's voice is obtained and saved in a storage area accessible to call management 404 of FIG. 4. The captured voice prints will later be compared to identify callers of interest.

If a “no” was determined in step 804, a determination of whether keyword comparison is required is performed (step 808). Completion of the voice print acquisition and storage also moves process 800 to step 808. If a “yes” results from step 808, speech to text conversion of the call to convert the spoken language into computer usable text is performed and resulting text is stored for later processing (step 810). For example, the voice communication is converted from an audio format into a computer usable text format suitable for searching, and is stored on a storage area accessible by call management 404 of FIG. 4.

If a “no” was obtained in step 808, a determination of whether an event based trigger was requested is performed (step 812). Performing step 810 also moves process 800 to step 812. If a “yes” is obtained in step 812, threshold values for the event triggers being monitored are obtained from a storage area, such as, storage area 424 of FIG. 4, for the configuration file, property file, or user preference information (step 814). For example, event based triggers are typically not related to the individual participants on the call, such as a specific user joining or leaving a call. Rather, event based triggers may specify quantity based values, such as the number of participants on a call, or perhaps the role, such as a chair-person, of a user who has joined a call.

A determination whether a trigger has occurred is made (step 816). If a “no” is obtained from the determination of step 816, process 800 reverts to step 804 to continue processing. If a “yes” was obtained in step 816, triggered criteria is established and process 800 moves to step 712 as seen in FIG. 7 and described previously.

When a trigger occurs, such as when keywords associated with a topic are recognized during the call, triggered criteria has been established and a respective rule may be fired to flash the window of the monitored call. In another example, when keywords are recognized in a background call, such as the monitored conference call, a keyword trigger criteria is established and a respective rule may execute generating a popup that contains the matched phrases, as well as flashing the window of the call. In yet another example, all text recognized by the speech to text processing through voice recognition may be displayed in a popup, with any key words emphasized by color or form of highlighting.

The capabilities described help a user manage multiple calls, in terms of deciding when to switch priority to and from a monitored call, wherein the call is typically in the background. By exploiting voice recognition software to monitor each call, the call management application may be configured to bring attention to a window of a call being monitored when certain keywords or phrases are recognized. Call management capabilities may also be used on active calls to compliment current conversation, for example, allowing a caller to select speech to text services to provide a text version of a portion of a call for later reference.

Thus, the illustrative embodiments provide a set of capabilities to analyze a specific call or calls to determine the existence of specific elements or events as they relate to the calls and initiate predetermined actions, in accordance with the identified element or event. The process may occur in the background, only notifying the requester when necessary, thereby typically allowing the requester to perform other tasks.

The invention can take the form of an entirely hardware embodiment, an entirely software embodiment, or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for multiple simultaneous call management using voice over internet protocol, the computer implemented method comprising:
responsive to receiving a request from a requester to monitor a call among multiple simultaneous calls using voice over internet protocol, creating a set of trigger criteria for the call;
monitoring the call for the set of trigger criteria;
responsive to one of the set of trigger criteria having been met, identifying triggered criteria;
selectively invoking a rule with respect to the triggered criteria to produce a result; and
notifying the requester of the result.

2. The computer implemented method of claim 1 wherein the request is received from one of a user and a programmatic source.

3. The computer implemented method of claim 1 wherein monitoring the call for the set of trigger criteria further comprises:
camping simultaneously on each call of multiple calls, one designated as a primary call, remaining calls designated as secondary calls; and
analyzing each call concurrently to determine whether one of a voice, keyword, and event trigger exists.

4. The computer implemented method of claim 1 wherein identifying triggered criteria further comprises:
comparing each one of the set of trigger criteria with a respective predetermined value.

5. The computer implemented method of claim 1 wherein selectively invoking a rule with respect to the triggered criteria to produce a result further comprises:
adjusting an audio level of a call associated with the triggered criteria; otherwise,
adjusting a visual representation of a call associated with the triggered criteria; and
a result of adjusting serving notice to the requester.

6. The computer implemented method of claim 1 wherein creating a set of trigger criteria for the call further comprises:
responsive to determining a voice criteria requested, capturing a voice print and storing the voice print in a storage area;
responsive to determining a keyword criteria requested, converting speech to text and storing the text in a storage area; and
responsive to determining an event based criteria requested, obtaining threshold values associated with the event based criteria from a storage area.

7. A data processing system for multiple simultaneous call management using voice over internet protocol, the data processing system comprising:
a receiver responsive to receiving a request to monitor a call among multiple simultaneous calls using voice over internet protocol, capable of creating a set of trigger criteria for the call;
a monitor capable of monitoring the call for the set of trigger criteria,
a comparator capable of determining one of the set of trigger criteria having been met, and identifying a triggered criteria;
a rule processor capable of selectively invoking a rule with respect to the triggered criteria to produce a result; and
a notifier capable of notifying a requester of the result.

8. The data processing system of claim 7 wherein the receiver receives the request from the requester which is one of a user and a programmatic device.

9. The data processing system of claim 7 wherein the monitor capable of monitoring the call for the set of trigger criteria further comprises a capability for:
camping simultaneously on each call of multiple calls, one designated as a primary call, with another designated a secondary call; and
analyzing each call concurrently to determine whether one of a voice, keyword, and event trigger exists.

10. The data processing system of claim 7 wherein the comparator capable of determining one of the set of trigger criteria having been met, and identifying a triggered criteria further comprises:
a capability for comparing each one of the set of trigger criteria with a respective predetermined value.

11. The data processing system of claim 7 wherein the rule processor capable of selectively invoking a rule with respect to the triggered criteria to produce a result further comprises a capability for:
adjusting an audio level of a call associated with the triggered criteria; otherwise,
adjusting a visual representation of a call associated with the triggered criteria; and
a result of adjusting serving notice to the requester.

12. The data processing system of claim 7 wherein the receiver capable of creating a set of trigger criteria for the call further comprises a capability:
responsive to determining a voice criteria requested, for capturing a voice print and storing the voice print in a storage area;
responsive to determining a keyword criteria requested, for converting speech to text and storing the text in a storage area; and
responsive to determining an event based criteria requested, for obtaining threshold values associated with the event based criteria from a storage area.

13. A computer program product for multiple simultaneous call management using voice over internet protocol, the computer program product comprising computer executable program code embodied on a computer usable recordable type medium, the computer executable program code comprising:
computer executable program code for receiving a request to monitor a call among multiple simultaneous calls using voice over internet protocol, creating a set of trigger criteria for the call;
computer executable program code for monitoring the call for the set of trigger criteria;
computer executable program code for a comparator for determining one of the set of trigger criteria having been met, and identifying a triggered criteria;
computer executable program code for selectively invoking a rule with respect to the triggered criteria to produce a result; and
computer executable program code for notifying a requester of the result.

14. The computer program product of claim 13 wherein the computer executable program code for receiving the request receives the request from one of a user and a programmatic device.

15. The computer program product of claim 13 wherein the computer executable program code for monitoring the call for the set of trigger criteria further comprises:
computer executable program code for camping simultaneously on each call of multiple calls, one designated as a primary call, with another designated a secondary call; and
computer executable program code for analyzing each call concurrently to determine whether one of a voice, keyword and event trigger exists.

16. The computer program product of claim 13 wherein the computer executable program code for a comparator for determining one of the set of trigger criteria having been met, and identifying a triggered criteria further comprises:
computer executable program code for comparing each one of the set of trigger criteria with a respective predetermined value.

17. The computer program product of claim 13 wherein the computer executable program code for selectively invoking a rule with respect to the triggered criteria to produce a result further comprises:
computer executable program code for adjusting an audio level of a call associated with the triggered criteria; otherwise,
computer executable program code for adjusting a visual representation of a call associated with the triggered criteria; and
the adjusting sufficient to serve notice to the requester.

18. The computer program product of claim 13 wherein the computer executable program code for creating a set of trigger criteria for the call further comprises:
computer executable program code responsive to determining a voice criteria requested, for capturing a voice print and storing the voice print in a storage area;
computer executable program code responsive to determining a keyword criteria requested, for converting speech to text and storing the text in a storage area; and
computer executable program code responsive to determining an event based criteria requested, obtaining threshold values associated with the event based criteria from a storage area.
